(19) United States
(12) Patent Application Publication
(10) Pub. No.: US 2007/0016539 A1
(43) Pub. Date: Jan. 18, 2007

(54) Smart meter parking system

(76) Inventors: Eric Groft, #3 Jamaica Plane, MA (US); Kirby Andrews, Westport, CT (US); Howard Kuff, Pettigrew, AR (US); Larry Berman, Delray Beach, FL (US); Martin Hald, West Linn, OR (US); Jonathan Pullen, Seattle, WA (US); Bruce Sherry, Woodinville, WA (US)

Correspondence Address: Intellectual Property Law Firm of R. J. Lasker,;Esq., Suite 900; Transpotomac Plaza, 1199 North Fairfax Street, Alexandria, VA, 22314, US

(21) Appl. No.: 11/179,779

(22) Filed: Jul. 13, 2005

(51) Int. Cl. G07B 15/02

(52) U.S. Cl. 705/418; 705/1

(57) ABSTRACT

A wireless electronic parking meter control system with a vehicle detection system for determining the presence or absence of a vehicle in a plurality of vehicle parking spaces and a number of electronic parking meters, each associated with a given vehicle parking space; a number of ICMs, at least one of which is interconnected with the vehicle detection system and the number of electronic parking meters; at least one ICM being wirelessly interconnected with the remaining number of ICMs; an INB wirelessly interconnected to the remaining number of ICMs and connected to the internet; a license plate recognition system including a mobile camera unit, desktop computer and a global positioning satellite terminal connected to the Internet; and a server interconnected to the internet via a router/firewall circuit for isolating the server from the internet.

### FIELD OF THE INVENTION

The smart meter parking system of the invention uses programmable electronic parking meters capable of accepting inputs from peripheral devices to react to arrival and departure events as sensed by vehicle detection sensors and operating in conjunction with an intelligent communications module with a memory for storing data relating to the condition of the parking system and capable of transmitting wirelessly to other devices in the system and a compact computer workstation and connecting to a meter wireless network and one or more forms of network connected to the internet.

### SUMMARY OF THE INVENTION

The vehicle detection sensors (VDS) determine vehicle arrivals and departures and the on/off status of inductor loop detectors and these status data are transmitted to either an Intelligent Communications Module (ICM) or directly to the electronic parking meters (EPM). The VDS include a microprocessor that is capable of bi-directional communications and enhanced detector status reporting. The VDS are similar to that described in U.S. patent application Ser. No. 09/866,919, entitled Electronic Parking Meter System, assigned to the same assignee as the present invention and incorporated herein by reference.

The ICM queries and receives from the EPM regarding transaction data and audit information, receives communications from the VDS, verifies the messages, logs the messages, and then relays them to a selected EPM. The ICM can transmit data to other peripheral devices either by request from such devices or by internal ICM programming. The ICM can send the necessary data and instructions to reprogram either the EPM or VDS.

The ICM can communicate via either the wired connection to an external device or via a wireless communication system to an Intelligent Network Bridge (INB). Such transmissions may enable the ICM to relay data between the VDS or the EPM and an external device.

The ICM is an electrical device consisting of a microprocessor, non-volatile memory storage and communication ports to: the VDS, EPM and a device designed to transmit wirelessly to other similarly equipped devices via a Radio Frequency Modem or similar device, and an external computer terminal. The microprocessor is any processor capable of performing the control of data flow between any and all of the connected devices. This processor is controlled by a code resident in the non-volatile memory storage and would be reprogrammable via either the interface to a wireless network or by direct connection to an external computer terminal. The preferred type of memory is a “flash” memory that does not require permanent power to retain the information stored therein and is easily reprogrammed with lower power requirements.

The EPM stores a record of events and current status of operability in their own memory, stores operational programming and a real time clock, receives inputs from either the ICM or the VDS and performs operations based on those inputs. The EPM can also be queried to transmit the contents of its memory to a requesting device to allow the offloading of transaction data, real time clock settings, event transactions and audit data for current operating status and revenues collected. The EPM are similar to those described in the U.S. patent application Ser. No. 09/866,919, but which also have the capability to accept inputs from peripheral devices in order to react to arrival and departure events. Such reactions add to or enhance meter functions currently available.

The INB is essentially a compact computer workstation with one or more microprocessors, data storage capabilities a Random Access Memory (RAM) and network connections to both the meter wireless network of ICM-attached RF modems and one or more other form of network connected to the internet. These connections may include a cellular modem to connect to cellular telephone networks of any available type (GPRS, GSM, CDMA), a wireless connection based on standard 802.11 protocols, hardwired connections via Ethernet (100T or Gigabit), hardwired connection to a Fiber-Optic network, hardwired connection to a co-axial cable network and/or hardwired connection to standard telephony systems. The INB is powered by any combination of battery, solar, direct connection to AC and direct connection to DC power sources.

The base requirements for the microprocessor, RAM and data storage aspects of the INB are sufficient to enable basic disk operation, routing of data streams between any enabled network connections, storage of data from up to 500 ICM-connected parking spaces for up to two weeks in a database accessible by the INB, basic data analysis of transactions in said database and presentation of basic reports to querying devices. The device will also need to run security software protecting it from internet based hacking attempts.

The smart parking meter system of the invention uses any handheld computing device that is equipped with an available port for communication via serial communications and/or any form of wireless communications for which the INBs can be equipped. The device must also be capable of storing data for up to 200 parking spaces at full capacity (estimated to require a total memory space of 128 MB for the handheld device). The choice of actual handheld will ultimately depend on the software/hardware combination the city uses for enforcement and/or maintenance activities. The goal is to integrate the data flows from the Smart Meter System into existing citation/maintenance systems should they be in use. Preferred hardware is defined by so-called “ruggedized” handhelds built on the Intel Strong Arm or other compatible processor running Microsoft's Windows Pocket PC 2002 or any similarly capable operating system for hand held devices with the capabilities described above.

To the extent to which the handheld computers are used to perform interpretation of visual images collected by an attached camera, additional storage and processing capacity are required.

A complete License Plate Recognition (LPR) system consists of two components: the first of these is a camera for collecting visual data and a second unit that collects positioning data via Global Positioning Satellites. The data collected by these units are then fed to software running on computers capable of interpreting the information collected to provide both the license plate number and the physical location. As each piece of information is time stamped with the time of observation the element of time can also be applied to the observation of a vehicle. Appended to the record of the license plate number, location and time, a visual image of the license plate is also stored as evidence for adjudication purposes.

A mobile camera unit such as a handheld unit that is directed by an individual riding in a vehicle or on foot patrolling a route. A united mounted to a vehicle patrolling a route could also be used. These units are directed at the license plates along these routes collecting digital images of the license plates. The images are collected along with information required to determine the relative position of a vehicle from the observing camera unit which is likely the distance and compass direction. Cameras may also be attached to handheld devices to collect the same information.

Global Positioning Satellite (GPS) systems are currently widely used to determine current location by a variety of applications. They work on the principle of determining relative position of a requesting device to three or more satellites situated in geosynchronous orbit around the earth. This information is used to triangulate the precise longitude and latitude for that device. The device for this application requires an accuracy of less than one meter.

A client-side Desktop Computer requires the ability to communicate with any handheld computers in service on the street for use by enforcement and/or maintenance personnel. The desktop computer also requires internet connectivity capabilities. Such connectivity is required not only to transmit any data collected by enforcement and/or maintenance personnel, but also to retrieve reporting from the data warehouse. The desktop computer also requires enough system resources in terms of memory, processor and data storage to process license plate images, GPS data and relative position data to generate usable observation data for matching against violation data by the data analysis engine residing on data warehouse computers.

To the extent that communications to and from devices in the network occur over the internet, a firewall system is needed at each end of the communication to decrease the likelihood of security breaches. The systems to be used can either be in the form of a hardware based solution or a strictly software solution in those situations where a hardware solution is impractical. Routers are also required to interconnect devices sharing physical networks behind firewalls. INBs act as routers for the street level network segments.

Network Servers Computers consist of one or more computers equipped with superior processors, RAM storage and data storage capabilities. These computers are located in a remote location or local to an individual client and accessed via the internet for data communications. They also act as the central storage location for parking data for one or more client cities, analysis engine, web page server, report generator and map server. The system of servers is expandable as needed to house increase amounts of data, numbers of visitors and enabled reporting capabilities. The data warehouse operates on any platform which allows for an implementation of a SQL-Based relational database. This database is paired with a custom built Java analysis engine that directs the database to perform calculations and store results for future reporting uses. The servers also host user interfaces to enable remote and/or local users to interact with the database to generate said reports, perform imports of new data and maintain data needed to perform accurate calculations of new data. These user interfaces can be either a customized portal interface or a web page driven interface. These servers also house a map serving engine which combines data regarding geographical locations and statistical data to generate map-based interfaces for users of the system. These interfaces perform both input and output functions.

The VDS determines vehicle arrivals and departures and the operational status of the induction loops. These communications are passed to either the ICM or directly to the electronic parking meter. Future plans for the detector include an upgraded microprocessor that is capable of bi-directional communications and enhanced detector status reporting. Such improvements allow for reporting from the detector of battery levels, actual inductance readings and other troubleshooting information. The improvements further allow for the detection parameters to be reprogrammed as needed without the need to send the units back to the factory.

The ICM receives any communications from the detector and logs the messages and then relays the message to the EPMs. The ICM acts as an interpreter for different types of electronic parking meters, thereby eliminating the need for multiple detector designs. It is also able to perform verification of message receipt by the EPMs. The ICM queries and receives data from the electronic parking meter regarding transaction data and audit information. These data are then stored on the ICM until such time it is required to transmit them to another device. Such requests are either initiated by an external device or by predefined operational parameters of the ICM. The ICM can also make requests of the vehicle detector in the case it is capable of bi-directional communications. The ICM also performs the sending of necessary data and instructions to reprogram either the parking meter or vehicle detector. The ICM communicates via either the wired connection to an external device or via its wireless communications system to an INB. Such communications are bi-directional in nature and are used to either request information from the ICM or send instructions and/or data required to perform actions on request. Such actions also include acting as a relay for data between the Detector or the electronic parking meter and an external device. The electronic parking meter stores a record of events and current status of operability in its own memory. It also stores operational programming and a real time clock and receives inputs from either the ICM or the vehicle detector directly and performs actions based on those inputs. These actions include changing of the meters programming and/or real time clock. The meter can also be asked to transmit the contents of its memory to a requesting device. This allows the offload of transaction data, real time clock settings, event transactions and audit data for current operating status and revenues collected.

Regardless of the type of information, the networked data warehouse servers stand ready to accept new data. They are capable of receiving many different data formats and processing them once data are received.

Data can be collected from the Meter-ICM-Detector system by either wired connection to an external computer or by periodic upload to the INB via wireless technologies. In the case that a wired connection is used, the connecting computer is then connected to the internet at some later time and the data transmitted via that connection to the networked servers acting as data warehouses. In using the INBs, information is collected wirelessly from the spaces by an INB and the information transmitted from the INB to the data warehouse over an active internet connection.

Information related to changes in system inventory (replacing a device with another) or maintenance worked being performed and are recorded by the individual performing the work. This data is recorded on a handheld device that is later connected to the internet. Once connected to the internet, the device transfers the information logged by the maintenance personnel to the data warehouse. This process also applies to citation data collected by enforcement personnel or the License Plate Recognition systems.

Each data record contains information regarding the device to which the information contained in the record pertains. The records also contain a timestamp of when the event occurred. The import engine first groups the information according to the device to which the events pertain.

Once the information has been grouped, it must be sequenced chronologically to develop a string of events. In the case of one-time events, such as issuance of a citation or maintenance repair, no further processing is needed. These items are directly stored for future cross reference within the relational database.

Some event types are paired to produce useful data groupings. Examples include Arrivals/Departures and Device Enter “Out of Order”/Device Exit “Out of Order”. These groupings are formed by examining the records sequentially and in each case an initiating event is paired with the matching event following immediately after it. These groupings result in space status groupings.

Once events have been paired to form space status groupings, the data is once again examined to match interim events with those groupings and in particular this relates to payment events for the electronic parking meters. Each payment is matched to the appropriate pair of arrival and departure events and recorded.

To produce statistics, the data being imported is compared to static information regarding the individual parking spaces. This information includes the following operating parameters:

(1) Hours of enforcement for parking regulations;

(2) Days of enforcement for parking regulations;

(3) Meter rates;

(4) Types of payment accepted and coins accepted;

(5) Types of features enabled (Meter reset, Free time on arrival, anti meter-feeding and/or progressive rate structures); and

(6) Length of “pre-pay” time (period of time prior to the beginning of enforcement hours during which payments are pre-purchased for use once enforcement hours begin).

Based on these parameters, the events recorded for each grouping are used to calculate statistics regarding system parameters such as occupancy, compliance, revenue, operability and enforcement.

As events records are paired and analyzed, the results and records are recorded in one or more tables and where applicable, the statistics are stored for each grouping of events. In other cases, some events (such as citations) are matched against other events or event groupings (such as parking space occupants) to determine additional information (such as whether a violation was cited) which can be recorded for later report generation.

When a user requests a report from the SOAR system, he or she is presented an interface to choose:

(1) Type of report to run;

(2) Date/Time range for the report;

(3) Selection criteria for spaces to be included in the report;

(4) Aspects of report to be included; and

(5) A way to group the parking spaces selected for presentation.

SOAR then retrieves the records while matching the request criteria to create the report.

Once the filtered records are retrieved they are aggregated first by space and then by grouping of parking spaces as requested by the user. The method of aggregating the statistics depends on the statistic being processed. The statistics can be: Summed; Averaged; or characterized as Maximum found or Minimum found.

As the process of gathering, filtering, aggregating and then presenting statistics for each space occupant at every parking space is a very time consuming process, a method of indexing is applied. This method stores statistics for each parking space on a daily, weekly and monthly basis. By using a combination of these pre-calculated statistics, the process of generating reports is greatly enhanced while maintaining flexibility in the filtering allowed by the system.

Reports can be presented as any one of the following types of documents:
(1) A portable document formant (pdf) as developed by Adobe Systems;
(2) A web page; or
(3) A color-coded map.

Data analysis uses a combination of both static parameters and dynamic data. The difference in the types of data is that static data is not dynamically applicable depending on the date or time of day. Although static parameters can be changed, changes affect reporting and data analysis universally.

Information stored for spaces on a static basis includes geographical location in terms of longitude and latitude, parking space type (parallel parking, angled or perpendicular), a descriptive name for the parking space and an index number for data processing purposes.

Information stored for policies includes Days of Operation, Hours of Operation, Rate Structure, Coil Valuation Parameters applied to the policy, the features enabled, the amount of free time given on arrival and the amount of pre-pay time. Information stored for the electronic parking meters includes the Manufacturer, meter type and serial numbers for the city, Innovapark and the Manufacturer. The coin parameters includes definitions for the coin and other payment denominations accepted and the amount of time given for each at each rate structure. The Groupings is a definition of both the grouping types available to users as well as the sub-groups for each grouping. For example, it would define a grouping called Zones and each of the individual zones under that grouping and all are user-definable.

Correction parameters affects how corrective logic for missing arrival or departure events are handled and applied. This process uses statistical averaging coupled with these static data as thresholds for generating estimated arrival and departure times when such data gaps are discovered in the imported data. The table below shows an example of the correction logic and the formula:
Parking Meter Missing Departure Least Squares Method=Sum(p(I)*[D(I)−C(I)])/sum(P(I)ˆ2), where:
P(I)=sum of coins for current car;

[D(I)−C(I)]=Departure time minus first coin drop time.

Sample transactions Table

| Code | Time | Coin | Drop | P(I) | [D(I) − C(I)] | Estimate % Error |
|---|---|---|---|---|---|---|
| A | 1:00 | — | | — | — | — |
| C | 1:02 | 0.25 | | — | — | — |
| C | 1;15 | 0.25 | | — | — | — |
| D | 1:30 | — | 0.5 | 28 | | 34.19 |
| A | 2:00 | — | — | — | | — |
| C | 2:05 | 0.1 | — | — | | — |
| D | 2:15 | — | 0.1 | 10 | | 6.84 |
| A | 3:00 | — | — | — | | — |
| C | 3:05 | 0.25 | — | — | | — |
| C | 3:06 | 0.25 | — | — | | — |
| C | 3:07 | 0.25 | — | — | | — |
| D | 4:00 | — | 0.75 | 55 | | 51.29 |

| | Numerator | Denominator |
|---|---|---|
| Car 1 | 14 | 0.25 |
| Car 2 | 1 | 0.01 |
| Car 3 | 41.25 | 0.5625 |
| Totals | 56.25 | 0.8225 |

Alpha=68.38905775 minutes/dollar

### BRIEF DESCRIPTION OF THE DRAWINGS

The above objects, features and advantages of the invention are readily apparent from the following description of the a preferred embodiment of the best mode for carrying out the invention when taken in conjunction with the following drawings, wherein:

FIG. 1 is flow diagram illustrating the process for license plate recognition (LPR)-based citations in accordance with the invention;

FIG. 2 is a block diagram representation of the inventive intelligent communications module (ICM) operational system;

FIG. 3 is a flow diagram illustrating the means by which progressive rate payments are valued by the SOAR analysis engine as part of the Smart Meter Parking System;

FIG. 3a shows the process for converting time values to revenue values in the context of progressive rates;

FIG. 4 is a flow diagram of the manner of evaluating the data for the parking meter system of the invention;

FIG. 5 is a flow diagram illustrating the process for coin valuation in the parking meter system of the invention;

FIG. 6 is a block diagram representation of the wireless posting of handheld data in accordance with the invention;

FIG. 7 is a block diagram representation of the inventive wireless parking meter system utilizing hardwire connection to the internet;

FIG. 8 is a block diagram representation of a fully wireless communication system of parking meter data in accordance with the invention;

FIG. 9 is a block diagram representation of the PDA enforcement communications system of the invention; and

FIG. 10 is a block diagram representation of a fully wireless PDA enforcement communication system.

### DETAILED DESCRIPTION

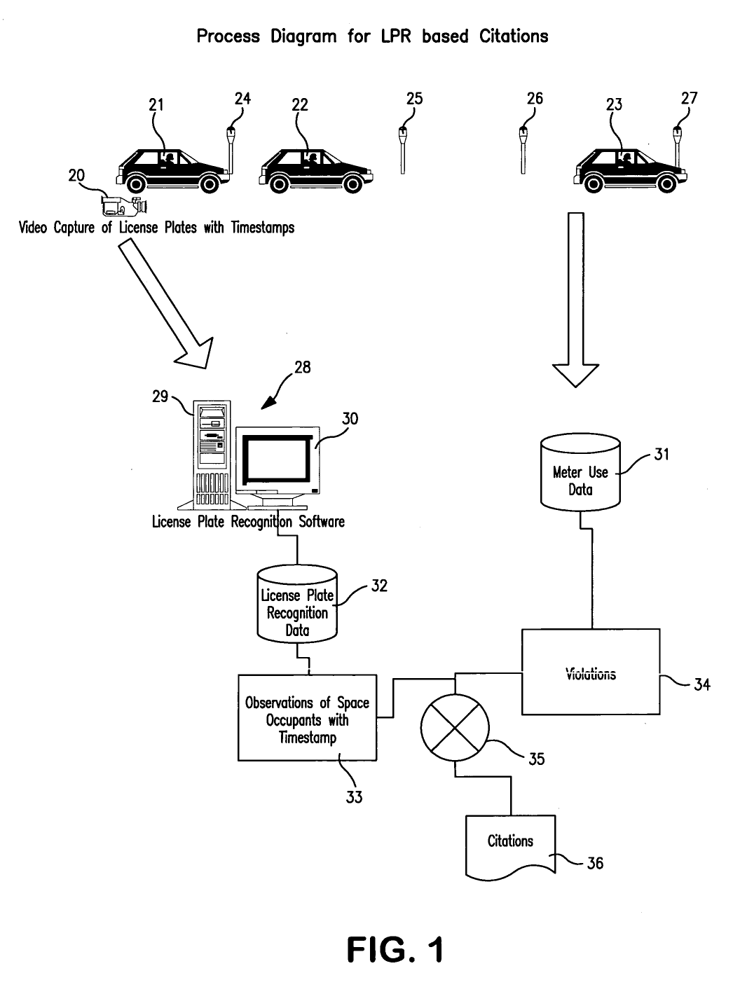

In the license plate recognition system (LPR) shown in FIG. 1 a video camera 20, which may be handheld or mounted on a vehicle, produces video images associated with a time reference) of the license plates of vehicles 21-23 with respect to parking meter spaces identified by electronic parking meters 24-27 which are transmitted to license plate recognition component 28 comprising a computer 29 and a video monitor 30. License plate recognition component 28 interprets the visual and time data to provide both the license plate number and the physical location of the particular vehicle. As each bit of information is time stamped with the time of observation the element of time can also be applied to the observation of a vehicle. Data from the electronic parking meters 24-27 with respect to at least the presence or absence of a vehicle in a respective parking space is transmitted to a meter use data storage device 31. The license plate recognition data is stored in memory 32 and that data along with observations of the parking space are gathered in space/time component 33. The EPM use data from memory 31 is input to violations 34 component which determines parking space violations from a comparison of the memory use data and the space/timer data from component 33 by comparator 35 resulting in the issuance of citations from citations component 36.

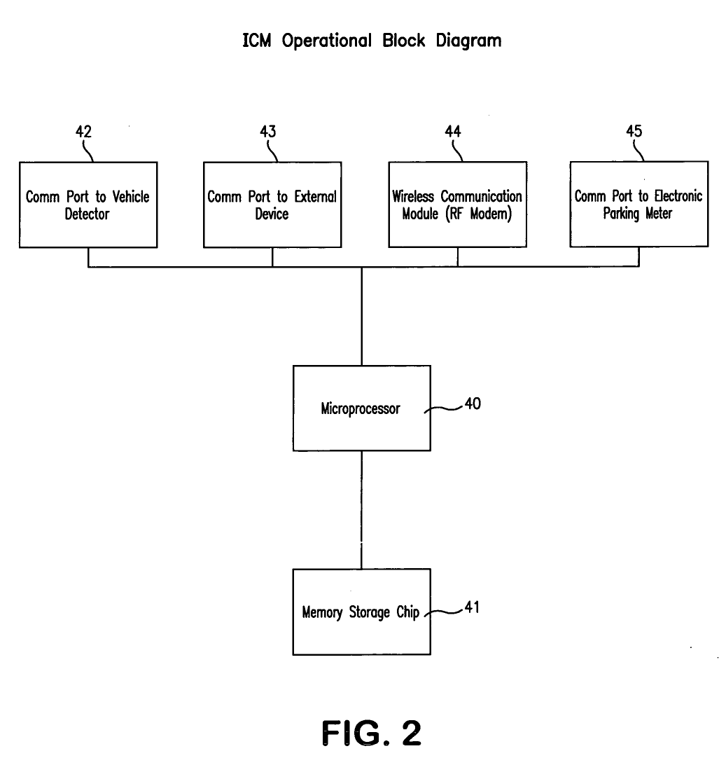

The ICM shown in FIG. 2 is an electrical device comprising microprocessor 40, non-volatile memory storage chip 41, and communication ports 42 to vehicle detector port 42, external device port 43, wireless communication module (RF modem) port 44 and EPM port 45. Microprocessor 40 is any processor capable of performing the control of data flows between any and all of the connected devices and is controlled by code resident in the non-volatile memory storage chip 41. Such code is reprogrammable via either the interface to a wireless network through port 44 or by direct connection to an external computer terminal through port 43. Memory storage chip 41 does not require permanent power to retain the information stored therein and is easily reprogrammed with lower power requirements.

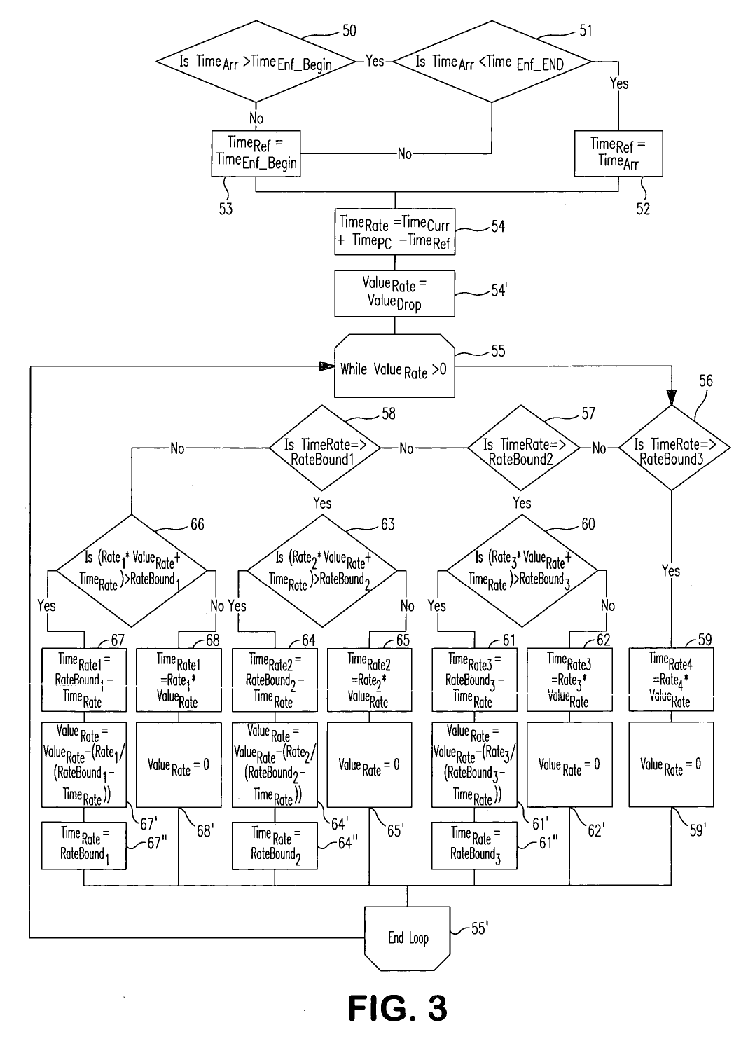

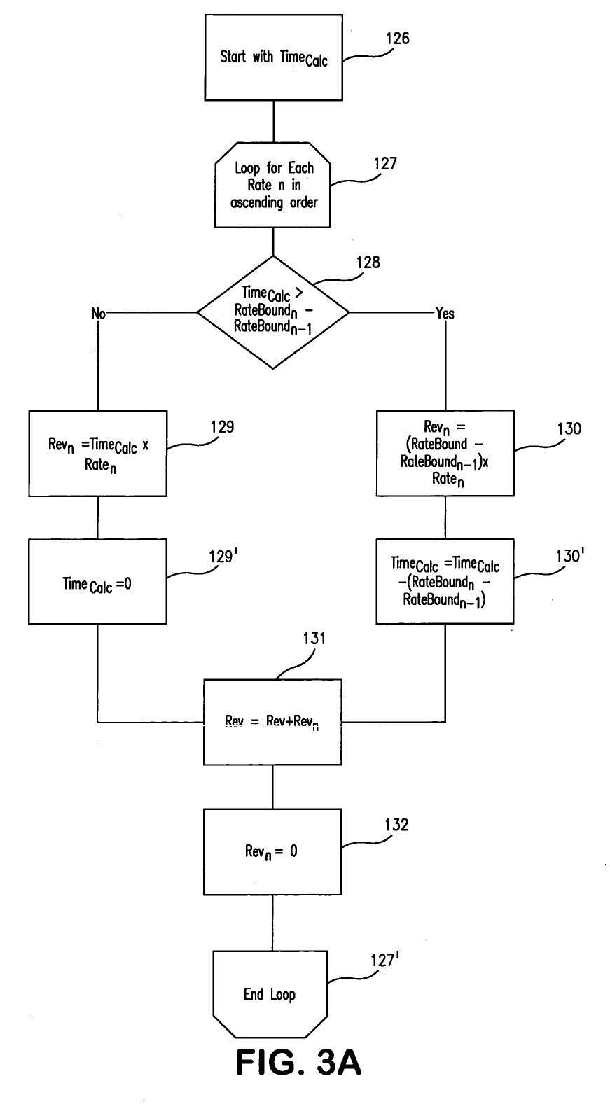

FIG. 3 is a flow diagram illustrating the means by which progressive rate payments are valued by the SOAR analysis engine as part of the Smart Meter Parking System. While the diagram specifically refers to coin payments and only employs three distinct rate tiers, the same or expanded logic can be used to apply to other forms of payment and additional rate tiers. The parameters employed in the flow diagram are defined as follows:

Time_{Arr}=Time of the Arrival Signal;

Time_{Enf Begin}=Predefined beginning of enforcement hours;

Time_{Enf End}=Predefined end of enforcement hours;

Time_{Ref}=Calculated point of reference for progressive rate program;

Time_{Curr}=Time of day at time payment is made;

Time_{Pc}=Time displayed on the electronic parking meter as represented by SOAR for calculations;

Value_{Drop}=the value of the coin being dropped or payment being made;

Time_{Rate}=Time determining which rate interval is to be applied to payment value being evaluated;

Value_{Rate}=the monetary value being applied towards granting additional time on the meter;

Rate₁, Rate₂, Rate₃, Rate₄ . . . Rateₙ—predetermined rates for the different time intervals; and

Ratebound₁, Ratebound₂, Ratebound₃ . . . Rateboundₙ=predetermined time limits for the different rates.

In the progressive rates flow diagram of FIG. 3 comparator 50 determines if the arrival of the occupant for which the payment is being evaluated is after the beginning of the enforcement hours. If it is, the flow passes to comparator 51 to ensure the arrival time is also prior to the end of the enforcement hours. If both of these conditions are met, the reference point for calculating progressive rates is set to be equal to the time of arrival in process 52. Should either comparator 51 or 52 prove false, the reference time for rate calculation is set equal to the beginning of enforcement hours by calculator circuit 53.

With the reference point from which to calculate rate intervals set, the calculation procedure passes to processes 54 and 54′ which sets the initial values for the Timeᵣₐₜₑ and Valueᵣₐₜₑ. The Timeᵣₐₜₑ is set to reflect point in time during the occupant's stay the payment will begin purchasing time. This is the time of the payment plus any time currently displayed by the meter less the reference time for rate calculation. The Valueᵣₐₜₑ is set equal to the value of the payment being made.

The calculation procedure then enters a logic loop which is performed repeatedly until the entire value of the payment has been processed. This loop of comparators and processes begins by first verifying that Timeᵣₐₜₑ is not already equal to or beyond the time limit for that parking space as defined by RateBoundₙ. In FIG. 3 a three-tiered rate structure is employed as an example with RateBoundₙ described as RateBound₃. As such this comparison is represented in comparator 56.

If the Timeᵣₐₜₑ does equal or exceed RateBoundₙ, the Valueᵣₐₜₑ is multiplied by Rateₙ (process 59) and is then set to a value of zero to exit the procedure loop (Process 59′).

If Timeᵣₐₜₑ does not exceed RateBoundₙ, the procedure Timeᵣₐₜₑ is compared to RateBoundₙ₋₁, RateBoundₙ₋₂, RateBound₃ and so on to RateBound₁ until it is found to be greater than or equal to one of these Rate boundaries (comparators 57 and 56). If Timeᵣₐₜₑ is found to be less than all rate boundaries, the Rate₁ is used as the rate for calculation. Likewise, if Timeᵣₐₜₑ is first found to be greater than or equal to Rate Bound₁, Rate₂ is used as the rate for calculation and so on. The procedure then applies a similar set of comparators and processes for each Rate₁ through Rateₙ.

First, it is determined if Valueᵣₐₜₑ when multiplied by the rate used for calculation and then added to the Timeᵣₐₜₑ would exceed the rate boundary for that rate (comparator 66 for Rate₁, comparator 63 for Rate₂ and comparator 60 for Rate₃.

If this is found to be true, the difference in time between the Timeᵣₐₜₑ and the Rate boundary is set as the value for the Timeᵣₐₜₑ₍ₙ₎ (Process 67 for the Rate₁, process 64 for the Rate₂, and process 61 for the Rate₃). Timeᵣₐₜₑ₍ₙ₎ is then used to figure what monetary amount is reflected by this time for the rate used for the calculation. This value is deducted from the Valueᵣₐₜₑ (process 67′ for the Rate₁, process 64′ for the Rate₂ and process 61′ for the Rate₃) Timeᵣₐₜₑ is then set equal to the rate boundary for the current rate (process 67″ for Rate₁, process 64″ for Rate₂ and process 61″ for the Rate₃) so the remaining amount for the Valueᵣₐₜₑ will be processed at the next higher rate when the procedural loop is repeated (loop 55).

If it is determined that the Valueᵣₐₜₑ when multiplied by the rate used for the calculation and then added to Timeᵣₐₜₑ would not exceed the rate boundary for that rate (comparator 66 for Rate₁, comparator 63 for Rate₂ and comparator 60 for the Rate₃), Valueᵣₐₜₑ is multiplied by the current the rate used for the calculation to find Timeᵣₐₜₑ₍ₙ₎ (process 68 for Rate₁, process 65 for Rate₂ and process 62 for Rate₃) Valueᵣₐₜₑ is then set equal to “0” in order to exit the procedure loop (process 68′ for the Rate₁, process 65′ for the Rate₂ and process 62′ for the Rate₃).

FIG. 3a shows how a time value is converted to a revenue value in the context of progresive rates. The parameters employed in this flow diagram are as follows:

Time_{Calc}=The time value being converted into a revenue amount

RateBoundₙ=The upper limit for the current rate level

RateBoundₙ₋₁=The upper limit for the previous rate level—If the calculation is for the first rate level, this value is set to “0”

Revₙ=The revenue value for the current rate level

Rev=The cumulative revenue value for all rate levels

The procedure starts with Time_{Calc} (process 126) and then enters a procedural loop (between loop start 127 and loop end 127′) which applies logic based on each rate level from Rate₁ through the maximum rate level defined. Time_{Calc} is analyzed to determine if it is greater than the upper limit for the current rate minus the upper limit for the previous rate. If this calculation is being applied to the first rate level, the previous rate limit is defined as “0” (comparator 128).

If the value of Time_{Calc} is less than the duration of the current rate interval, it signifies that all of that time is applicable to the current rate. As such Time_{Calc} is multiplied by the current rate (process 129) to calculate the revenue represented by that time value. Since all of the time represented by Time_{Calc} applies to the current time interval, the variable is set to “0” so that it will not be double-counted when the value for subsequent rate intervals is calculated (process 129′).

Otherwise, only a portion of the time represented by Time_{Calc} applies to the current rate interval. In this case, the duration of the current rate interval is multiplied by the current rate to find the revenue value from the current rate interval (process 130). Time_{Calc} is then reduced by the duration of the current rate interval (process 130′) in order to assure it will not be double-counted when the value for subsequent rate intervals is calculated.

In either of these cases, the procedure then proceeds by incrementing Rev by the value calculated for Revₙ (process 131). As such, once each rate interval has been processed, Rev will represent the cumulative total revenue value for the initial value of Time_{Calc}. Revₙ is then set to “0” (process 132) so the process can be repeated for the next rate interval.

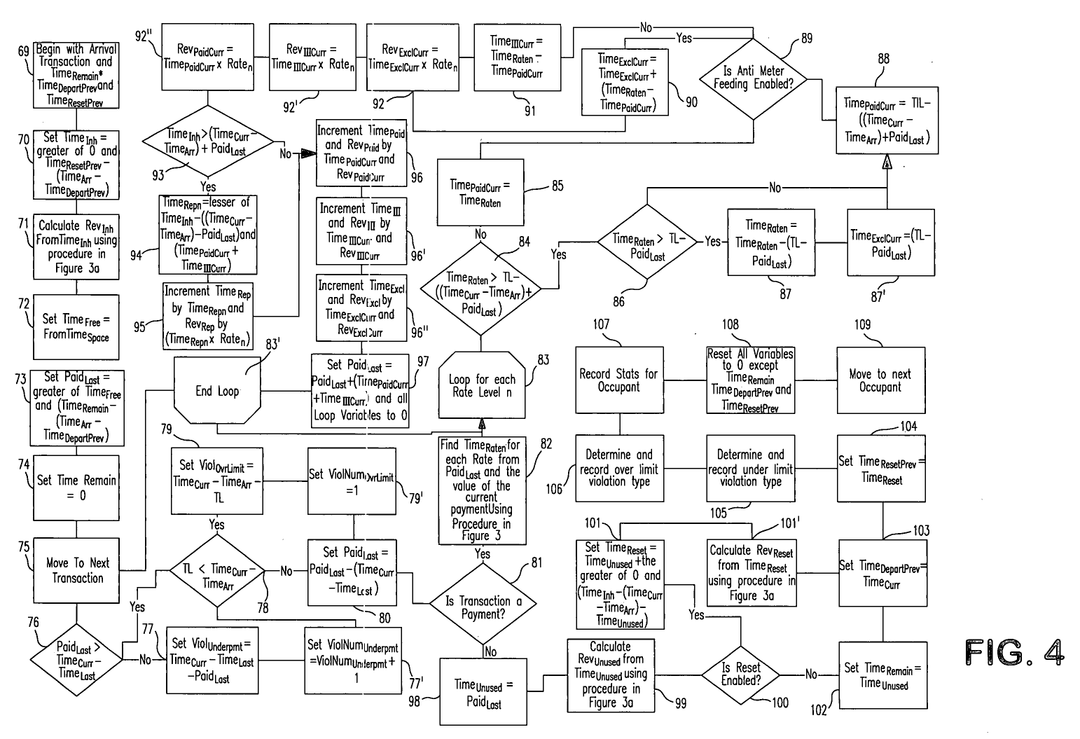

FIG. 4 illustrates the procedural flow used to determine how the individual transactions are evaluated within the context of a defined occupant. This procedure is undertaken after the transactions are grouped and sequenced in such a way that an occupant can be defined as an arrival transaction, its immediate predeceasing departure and all payment transaction between them chronologically for a given meter. The various parameters employed in FIG. 4 are defined as follows:

Time_{Remain}=Time remaining of the meter after the previous departure—this is zero when the reset is enabled

Time_{DepartPrev}=Time of the previous departure

Time_{ResetPrev}=Amount of time reset at the previous departure

Time_{Arr}=Time of the arrival for the current occupant

Time_{Inh}=Amount of time inherited by the current occupant. This reflects time that would have been on the meter, but is not due to resetting the time to “0” at departure.

Rev_{Inh}=Amount of money represented by Time_{Inh}

Time_{Free}=Amount of time given free to current occupant upon arrival

FreeTime_{Space}=Amount of free time as defined by the space policy

Paid_{Last}=Amount of time paid for at the time of the current transaction

Time_{Curr}=Time of the current transaction

Time_{Last}=Time of the previous transaction

Viol_{Underpmt}=Time during current occupant's stay in which the occupant was in violation due to non-payment for time

Vio_{Numunderpmt}=Number of times an occupant is in violation due to non-payment for time

TL=The time limit for the space as defined in the space policy

Viol_{OverLimit} Time during current occupant's stay in which the occupant was in violation due to occupying the space longer than the allowed time limit

ViolNum_{OcerLimit}=Number of times an occupant is in violation due to occupying the space londger than the allowed time limit

Time_{Raten}=Time associated with the current payment and rate level which was paid for

Time_{ExelCurr}=Time associated with the current payment and rate level which was not granted by the meter

Time_{IllCurr}=Time associated with the current payment and rate level which was granted by the meter, but is beyond the time lime for the space

Time_{PaidCurr}=Time associated with the current payment and the rate level which was granted by the meter is legally paid for

Rev_{ExelCurr}=Monetary value of Time_{ExelCurr}

Rev_{IllCurr}=Monetary value of Time_{IllCurr}

Rev_{PaidCurr} Monetary value of Time_{PaidCurr}

Rateₙ=Rate charged for the current interval

Time_{Repn}=Time associated with the current payment and rate level which was repurchased from a previous occupant

Time_{Rep}=Cumulative time which was repurchased from a previous occupant

Rev_{Rep}=Monetary value of Time_{Rep}

Time_{Paid}=Cumulative time which was granted by the meter as legally paid for Rev_{Paid}=Monetary value of the Time_{Paid}

Time_{Ill}=Cumulative time which was granted by the meter, but is beyond the time limit for the space

Rev_{Ill} Monetry value of the Time_{Ill,}

Time_{Exel}=Cumulative time which was not granted by the meter

Rev_{Exel}=Monetary value of Time_{Exel}

Time_{Unused}=Time remaining of purchase and granted time upon departure of occupant

Rev_{Unused}=Monetary value of Time_{Unused}

Time_{Reset}=Time reset by a meter at depature

Rev_{Reset}=Monetary value of Time_{Reset}

The evaluation process begins with three data elements retained from the previous occupant. These items are the time of that occupant's departure, the time reset by the meter at that time and the amount of time remaining on the meter after the departure. It should be noted that if time was reset, there will be no time remaining on the meter after departure (process 69).

Next the amount of time that would have been on the meter is determined using the time of the current occupant's arrival in the space, the time of the previous departure and the amount of time, if any, that was reset by the meter. If the calculation results in a negative amount of time, this value defaults to “0” process 70). Once this amount of time has been defined, its monetary equivalent is determined using the process shown in FIG. 3a (process 71).

The amount of time given as free time to this occupant is then determined based on the space's policy (process 72). This time is considered in addition to the time remaining on the meter after the previous occupant's departure when determining the amount of time the meter would have displayed after the arrival of the current occupant (process 73). The data variable storing the amount of time remaining after the previous occupant is then cleared to avoid double counting when counting subsequent occupants (process 74).

The procedure then proceeds with the next transaction for the current occupant (process 75). At this point, the time between the previous transaction and the current transaction is analyzed to determine if violations occurred during this time and of what kind. The first test is to see if the time elapsed between the previous transaction and the current one is greater than the amount of time on the meter at the conclusion of the last event (comparator 76). If so, this indicates an underpayment violation (the meter was expired at some point during the occupant's stay in the space). This amount of time is calculated and noted (process 77) and the occurrence of a violation of this type is noted in order to track the number of times the meter shows and expired meter flag (process 77′).

The time of the current transaction event is then analyzed to determine if it occurs within the prescribed time limit for the space (comparator 78). If not, the amount of time elapsed since the arrival of the occupant is reduced by the length of the space's time limit to determine the length of over limit violation process (process 79) and the counter for over limit violations is set to “1” (process 79′).

The variable storing the amount of time displayed by the meter is then adjusted to reflect the amount of time elapsed between the current transaction and the previous one (process 80). From this point, the transaction is analyzed one of two ways. The analysis is determined by the transaction type (comparator 81). Payment transactions proceed to payment analysis (process 82) and departure transactions to occupant statistic aggregation (process 98).

The first step in payment analysis is to determine the application of the payment among the different rate intervals as defined by progressive rates. This is done using the process outlined in FIG. 3 (process 82). Once the process to define the application of the payment among each payment interval is defined, the analysis enters a loop which examines each interval individually (loop start 83 through loop end 83′).

The first step in the loop is to determine if there are any time limit implications for the portion of the payment at the current interval (comparator 84). If there are no implications, the analysis proceeds to the categorization of the payment time and monetary values starting with process 89.

Otherwise, the analysis continues to determine the nature of the time limit implications to the payment at the current rate interval. The first check determines if the amount of time valued at this rate interval would cause the amount of time displayed by the meter to exceed the prescribed time limit (comparator 86). As the meter would not grant time beyond, the portion of the payment that would have been excluded by the meter must be noted separately and adjustments made to the time available for allocation to the other categories. This is accomplished by first reducing the time available for distribution among the categories by the amount of time that would be excluded by the meter (process 87). This amount of time is then added to the excluded time category for the current rate interval (process 87′). At this point the amount of time from the current rate interval for which time was legally purchased and granted by the meter is determined to be equal to the time remaining for purchase within the time limit for the space (process 88).

Next it is determined if the space employs an Anti Meter Feeding process (process 89). If so, the difference between the time available for allocation at the current rate interval and the time categorized as legally paid and granted is added to the excluded category (process 90). Otherwise, the same value is categorized as illegally paid for and granted time (process 91). The different time values pertaining to the current rate interval are then converted to monetary values by multiplying them by the current rate (processes 92, 92′ and 92″).

The payment is then analyzed to determine if it accounts for repurchasing of time reset from a previous occupant (process 93) by examining the amount of time already purchased previous to the current payment and the time elapsed since arrival. If time is available for repurchase, the amount of time purchased and granted by the meter for the current transaction is compared to the amount of time actually repurchased at the current rate interval (process 94). This value is then used to increment the total time repurchased and its monetary value (process 95).

At this point, the cumulative amounts of time and money for legally paid and granted, illegally paid and granted and excluded categories are incremented by those values as calculated for the current rate interval (processes 96, 96′ and 96″). The amount displayed by the meter is then incremented by the combination of time legally and illegally paid for and granted by the meter (process 97) and the loop ends (end loop 83′) returning to process 75 and the processing of the next transaction.

Statistical aggregation for the current occupant occurs when a departure transaction is encountered for the occupant as it is the final transaction (comparator 81). This process begins by classifying the time remaining on the meter at the moment this transaction event occurs as unused time (process 98). This time is then calculated into its monetary equivalent using the procedure outlined in FIG. 3a (process 99). If reset is enabled for the meter (comparator 100), the unused time from the current occupant is added to any available, repurchasable time from previous occupants in order to be made available to the subsequent occupants for repurchase (process 101) and its value is converted to a monetary amount using the process outlined in FIG. 3a (process 101′). Should reset not be enabled, the unused time is categorize as time remaining on the meter after the departure for application to paid time available to subsequent occupants (process 102).

The time of the current transaction is then noted as the time to be used by the next occupant representing the departure time of the previous occupant (process 103). The time reset by the meter is also noted for the next occupant in a similar manner (process 104).

The process continues by examining the type of violations that occurred in the space for the current occupant. Underpayment violations are classified as either an “Expired” violation if the meter experienced at least one payment, but was in violation at some point during the occupant's stay and as a “Never Paid” violation if no payment was received, but the meter showed as expired during the stay (process 105). Over limit violations are then classified as “Never Paid” if the underpayment violation type was also classified as such, “Partially Paid” if the underpayment violation type was classified as “Expired” and “Fully Paid” if no underpayment violation existed (process 106).

Finally, the occupant's cumulative statistics are recorded in the database (process 107) and all variable set to “0” excepting those needed by subsequent occupant evaluations (process 108). The process then moves to the next set of occupant transaction events (process 109).

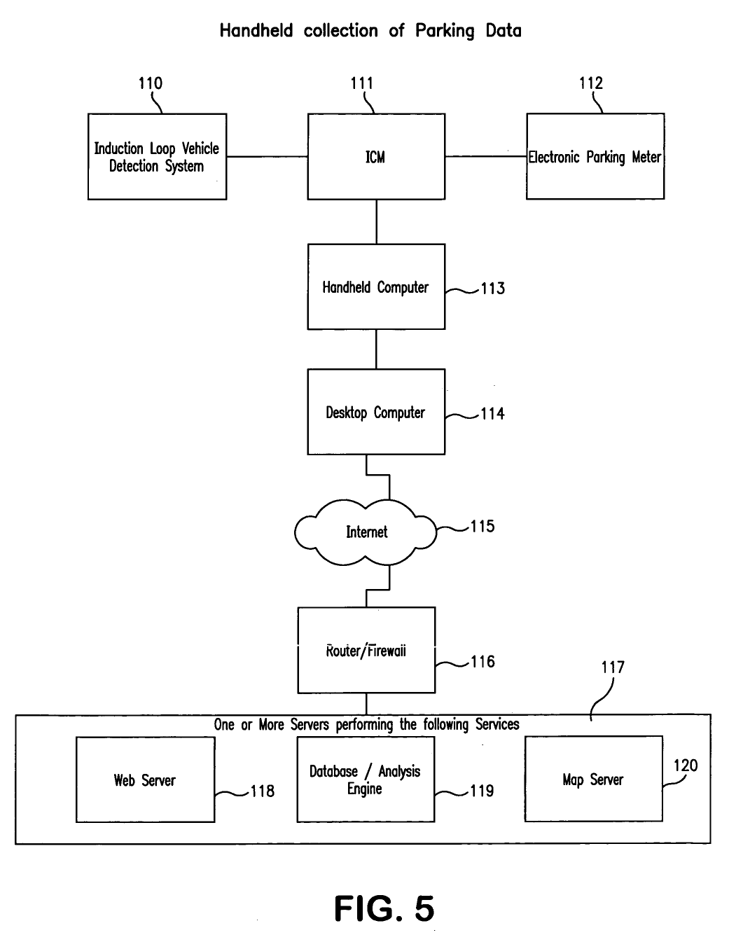

FIG. 5 illustrates a flow diagram in block diagrammatic format for providing the handheld collection of parking data. AN induction loop vehicle detection system 110 provides a data input to Intelligent Communications Module (ICM) 110 which also receives input data from EPMs 112 and includes a microprocessor, non-volatile memory storage and communication ports to induction loop vehicle detection system 110 and EPM 112. The microprocessor controls the data flows between the connected devices and is controlled by a resident in the non-volatile memory storage and the code is reprogrammable via either the interface to a wireless network or by direct connection to an external computer terminal. The preferred type of memory is a “flash memory” as it does not require permanent power to retain the information stored on it and is easily programmed with lower power requirements.

The smart parking meter system of the invention uses any handheld computing device 113 that is equipped with an available port for communication via serial communications and/or any form of wireless communications for which the INBs can be equipped. The device must also be capable of storing data for up to 200 parking spaces at full capacity (estimated to require a total memory space of 128 MB for the handheld device). The choice of actual handheld computer 113 will ultimately depend on the software/hardware combination the city uses for enforcement and/or maintenance activities. The goal is to integrate the data flows from the Smart Meter System into existing citation/maintenance systems should they be in use. Preferred hardware is defined by so-called “ruggedized” handhelds built on the Intel Strong Arm or other compatible processor running Microsoft's Windows Pocket PC 2002 or higher operating system with the capabilities described above. As shown in FIG. 3, handheld computer 113 communicates with ICM 111 and desktop computer 114.

To the extent to which the handheld computers are used to perform interpretation of visual images collected by an attached camera, additional storage and processing capacity are required.

A client-side Desktop Computer 114 requires the ability to communicate with any handheld computers 113 in service on the street for use by enforcement and/or maintenance personnel. The desktop computer 114 also requires internet connectivity capabilities such as with the internet 115. Such connectivity is required not only to transmit any data collected by enforcement and/or maintenance personnel, but also to retrieve reporting from the data warehouse. The desktop computer 114 also requires enough system resources in terms of memory, processor and data storage to process license plate images, GPS data and relative position data to generate usable observation data for matching against violation data by the data analysis engine residing on data warehouse computers.

To the extent that communications to and from devices in the network occur over the internet 115, a firewall system 116 is needed at each end of the communication to decrease the likelihood of security breaches. The systems to be used can either be in the form of a hardware based solution or a strictly software solution in those situations where a hardware solution is impractical. Routers are also required to interconnect devices sharing physical networks behind firewalls. INBs act as routers for the street level network segments.

Servers 117 include web server 118, data/analysis engine 119 and map server 120 and are connected to receive the data from router/firewall 116.

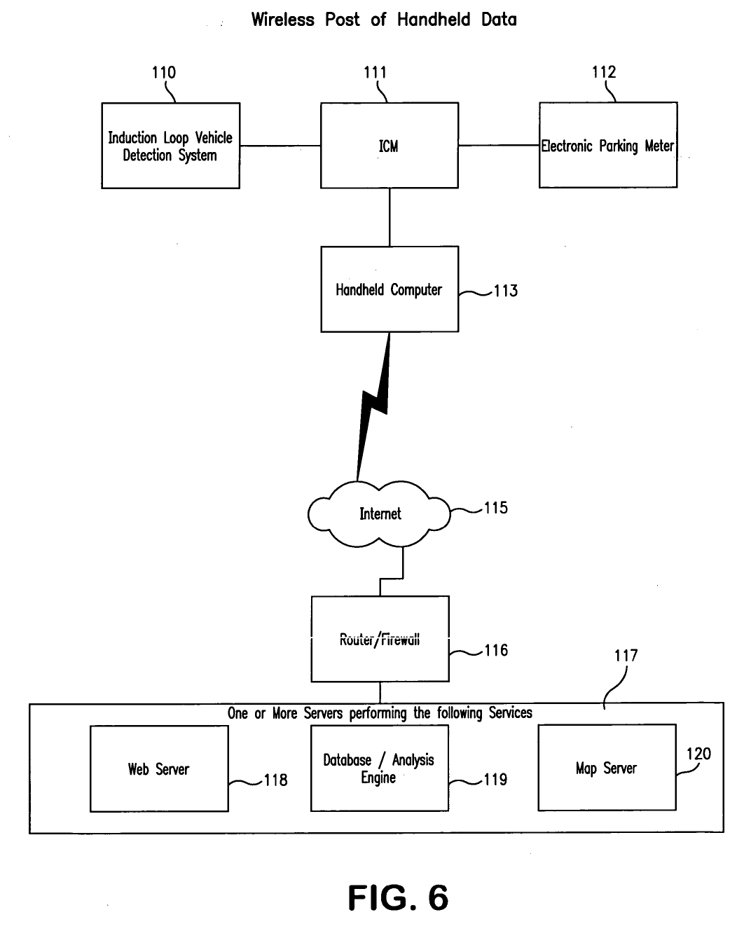

The wireless posting of handheld data shown in FIG. 6 is identical to the handheld collection of parking data system of FIG. 5 with the exception that the wireless posting of handheld data system of FIG. 6 does not include desktop computer 114 and handheld computer 113 communicates by wireless transmission to the internet 115.

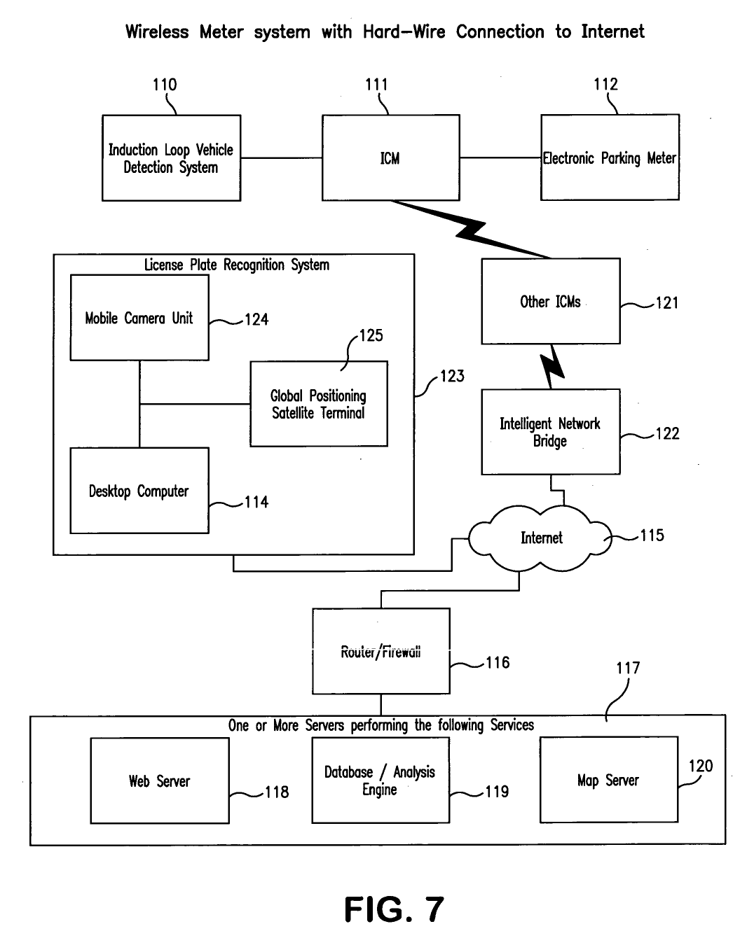

FIG. 7 shows a wireless parking meter system including a hard-wire connection to the internet. This system includes the same loop vehicle detection system 110, ICM 111, EPM 112, internet 115, router/firewall 116 and servers 117 as shown in FIGS. 6 and 7, for example. In the wireless parking meter system shown in FIG. 7 ICM 1111 communicates by wireless communication with other ICMs 121 which in turn have wireless communication with INB 122. INB 122 is hard-wired to the internet 115 and connected to router/firewall 116 as previously described.

Internet 115 is also hard-wired to LPR system 123 which consists of three components: the first of these is a mobile camera unit 124 for collecting visual data and another unit that collects positioning data via Global Positioning Satellites, namely global positioning satellite terminal 125. The data collected by these units are then fed to software running on desktop computers 114s capable of interpreting the information collected to provide both the license plate number and the physical location. As each piece of information is time stamped with the time of observation the element of time can also be applied to the observation of a vehicle. Appended to the record of the license plate number, location and time, a visual image of the license plate is also stored as evidence for adjudication purposes.

A mobile camera unit 124 could be a handheld unit that is directed by an individual riding in a vehicle or on foot patrolling a route. A united mounted to a vehicle patrolling a route could also be used. These units are directed at the license plates along these routes collecting digital images of the license plates. The images are collected along with information required to determine the relative position of a vehicle from the observing camera unit. Namely, this is likely the distance and compass direction. Cameras may also be attached to handheld devices to collect the same information.

Global Positioning Satellite (GPS) systems are currently widely used to determine current location by a variety of applications. They work on the principle of determining relative position of a requesting device to three or more satellites situated in geosynchronous orbit around the earth. This information is used to triangulate the precise longitude and latitude for that device. The device for this application requires an accuracy of less than one meter.

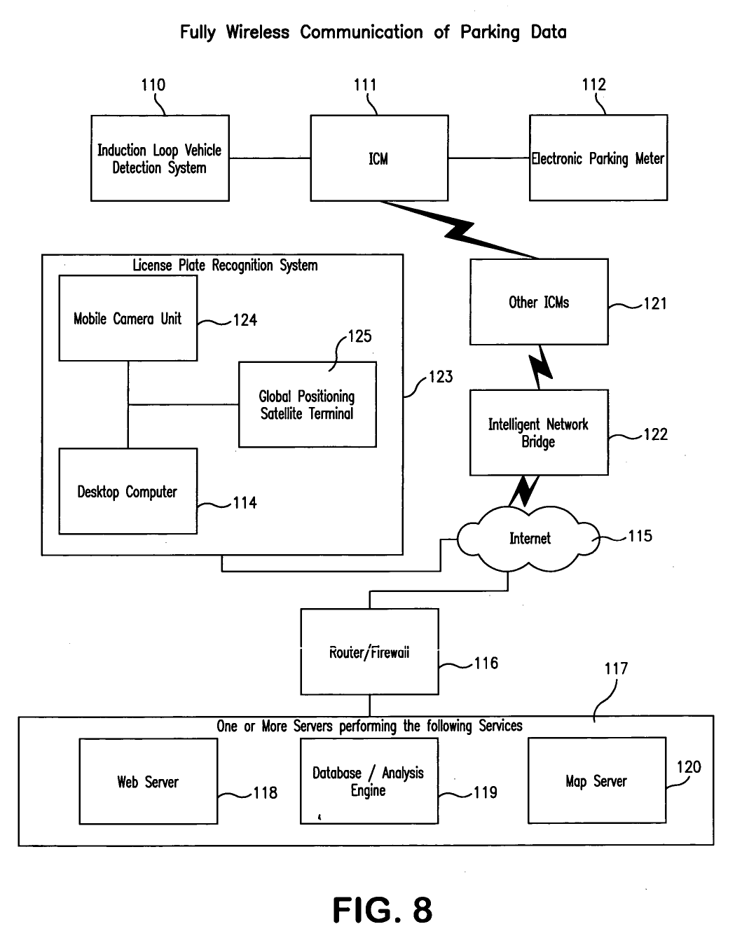

FIG. 8 illustrates a fully wireless communication of parking meter data and is identical to the wireless meter system shown and described in FIG. 7 with the exception that there is wireless communication rather than hardwire communication between INB 122 and the internet 115.

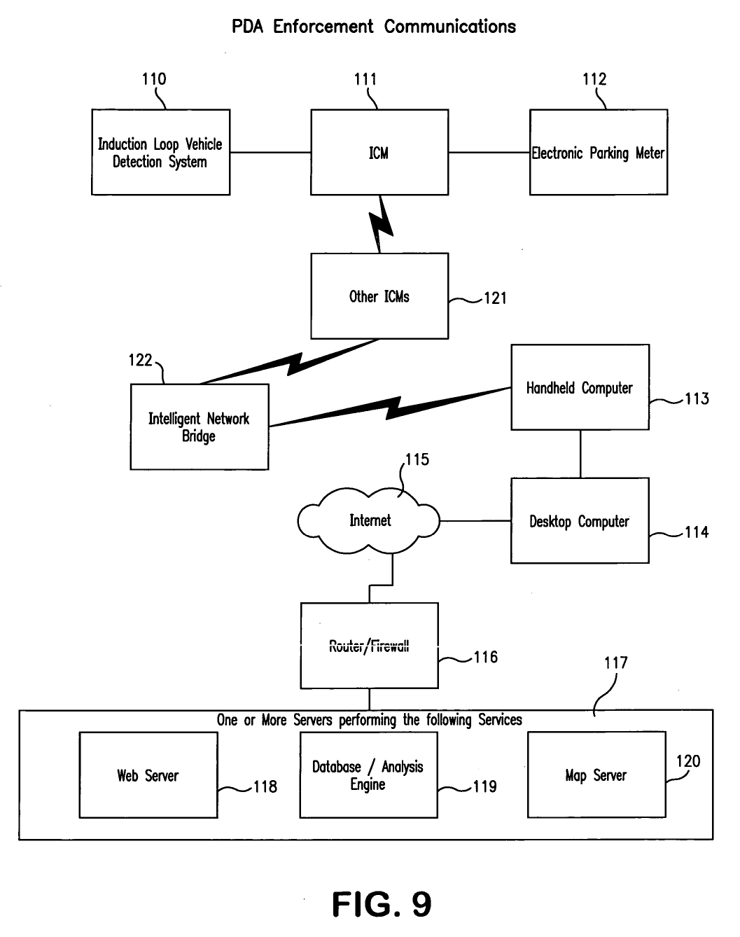

FIG. 9 illustrates a block diagram of an embodiment for carrying out PDA enforcement communications utilizing wireless communication between ICM 111 and other ICMs 121; wireless communication between the other ICMs 121 and INB 122; and wireless communication between INB 122 and handheld computer 113.

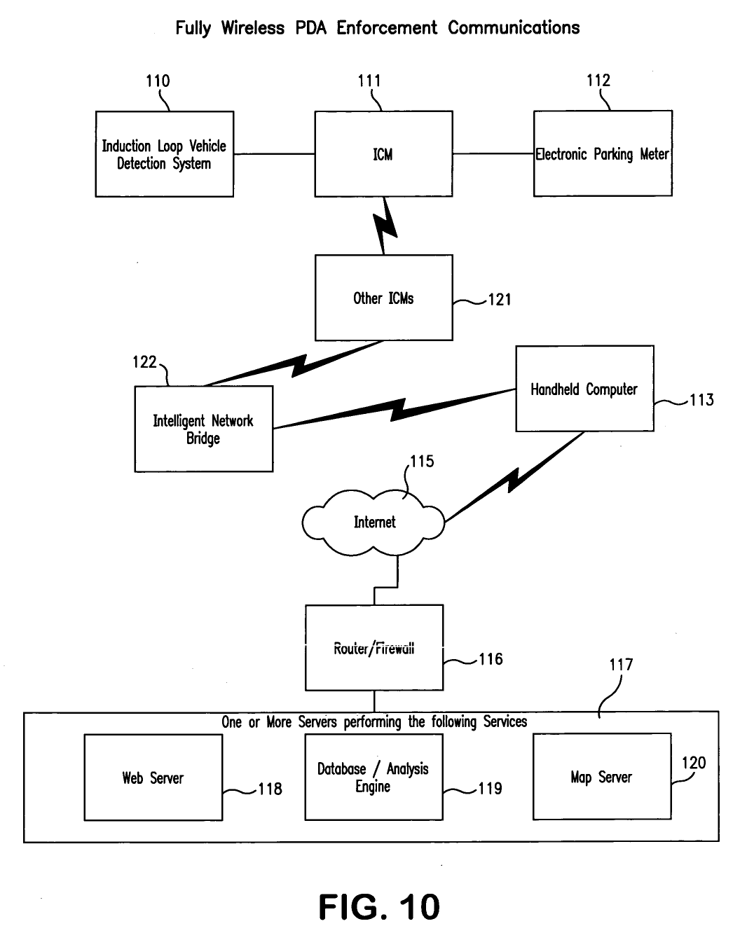

FIG. 10 illustrates a block diagram of an embodiment for carrying our fully wireless PDA enforcement communications and utilizing wireless communication between ICM 111 and the other ICMs 121; wireless communication between INB 122 and the other ICMs 121; wireless communication between INB 122 and handheld computer 113; and wireless communication between the internet 115 and the handheld computer 113.

Therefore it is desired that the present invention not be limited to the specific embodiments described herein, but that it include any and all such modifications and variations that would be obvious to those skilled in the art to which the invention is directed. It is our intention that the scope of the present invention should be determined by any and all such equivalents of the various terms and structure as recited in the following annexed claims.

1. A wireless electronic parking meter control system, comprising:
a vehicle detection system for determining the presence or absence of a vehicle in a plurality of vehicle parking spaces;
a number of electronic parking meters, each associated with a given vehicle parking space;
a number of ICMs, at least one of which is interconnected with said vehicle detection system and said and number of electronic parking meters;
said at least one ICM being wirelessly interconnected with the remaining number of ICMs;
an INB wirelessly interconnected to the remaining number of ICMs and connected to the internet;
a license plate recognition system including a mobile camera unit, desktop computer and a global positioning satellite terminal and being connected to the Internet; and
a server interconnected to the internet via a router/firewall circuit for isolating the server from the internet.

2. A wireless electronic parking meter control system as in claim 1, wherein said server includes a web server, database/analysis engine and a map server.

3. A wireless electronic parking meter control system as claimed in claim 1, wherein, said INB is wirelessly connected to the internet.

4. A wireless electronic parking meter control system as in claim 3, wherein said server includes a web server, database/analysis engine and a map server.

5. A wireless electronic parking meter control system, comprising:
a vehicle detection system for determining the presence or absence of a vehicle in a plurality of vehicle parking spaces;
a number of electronic parking meters, each associated with a given vehicle parking space;
a number of ICMs, at least one of which is interconnected with said vehicle detection system and said and number of electronic parking meters;
said at least one ICM being wirelessly interconnected with the remaining number of ICMs;
an INB wirelessly interconnected to the remaining number of ICMs;
handheld computers for storing data relating to the plurality of parking spaces and wirelessly interconnected to said INB;
a desktop computer connected to the handheld computers and to the Internet for communicating enforcement and/or maintenance personnel and to store license plate images, GPA data and relative position data a server interconnected to the internet via a router/firewall circuit for isolating the server from the internet.

6. A wireless electronic parking meter control system as in claim 5, wherein said server includes a web server, database/analysis engine and a map server.

7. A wireless electronic parking meter control system as in claim 5, wherein said desktop computer is wirelessly connected to the Internet

8. A wireless electronic parking meter control system as in claim 7, wherein said server includes a web server, database/analysis engine and a map server.
